(19) United States
(12) Patent Application Publication
(10) Pub. No.: US 2012/0031976 A1
(43) Pub. Date: Feb. 9, 2012

(54) Approach of disposing waste

(75) Inventor: Chin Tao Cheng, Shenzhen (CN)

(73) Assignee: Yan BAO

(21) Appl. No.: 12/806,147

(22) Filed: Aug. 6, 2010

(51) Int. Cl. G06K 19/06; G06K 7/12

(52) U.S. Cl. 235/469; 235/494

(57) ABSTRACT

This invention provides an approach of disposing waste for marking different products of waste sources with different color classification iconic codes at the time of production. The color classification iconic code contains at least one specific color used to indicate the category of the product, and this specific color has the maximum distribution area in the color classification iconic code or occupies the entire color classification iconic code. Various containers used to contain different wastes are marked with the corresponding colors that indicate product categories in the color classification iconic codes. With the approach of disposing waste in this invention, even the children at 3-5 years old and illiterates can classify the waste and discard it into the matched trash can according to the color classification iconic code. In this way, the same type of waste can be collected together conveniently for recycling.

### BACKGROUND OF THE PRESENT INVENTION

1. Field of Invention

This invention relates to an approach of disposing waste.

1. Description of Related Arts

By now, there is not a thorough solution to dispose wastes in the world. In most cases, the waste is buried or burnt. However, the disposal in this way not only contaminates the environment, but also wastes resources. The basic reason is that the collected wastes are not classified. As a matter of fact, a big variety of wastes are mixed together, and they cannot be processed for recycling or the recycling cost is too high. Take plastics for example, there are a lot of plastic products in various forms. Even an expert can hardly classify them with naked eyes, not to mention the common people. Subsequently, different plastic wastes are mixed together or even mixed with other kinds of wastes. It is difficult to reuse these collected wastes later, because the mixed plastics in different categories can hardly be reprocessed, and it is almost impossible to classify the collected wastes or the cost to do so is too high. Therefore, the plastic waste is among the wastes which are most difficult to recycle.

### SUMMARY OF THE PRESENT INVENTION

The embodiment of this invention is to provide an approach of disposing waste, so as to solve the problem of recycling difficulty arising from the fact that the collected wastes cannot be classified.

The embodiment of this invention is implemented as follows:

Different products of waste sources are marked with different color classification iconic codes at the time of production. The said color classification iconic code contains at least one specific color used to indicate the category of the product, and this specific color has the maximum distribution area in the color classification iconic code or occupies the entire color classification iconic code. Various containers used to contain different wastes are marked with the corresponding colors that indicate product categories in the said color classification iconic codes.

In comparison with the prior art, the above technical scheme marks different products of waste sources with different color classification iconic codes at the time of production. The color classification iconic code contains at least one specific color used to indicate the category of the product, and this specific color has the maximum distribution area in the color classification iconic code or occupies the entire color classification iconic code. Various containers used to contain different wastes are marked with the corresponding colors that indicate product categories in the color classification iconic codes. In the Specifications, the containers for different wastes can be trash cans or trash bags of any shapes, and all the corresponding colors refer to colors that are basically or completely the same visually. In other words, if the product of waste source consists of one ingredient only, the entire color classification iconic code contains one color only, and the matched waste container is in the corresponding color; in this way, the color of the color classification iconic code is mapped to the color of the waste container, so even the children at 3-5 years old and illiterates can subconsciously classify the waste and discard it into the trash can in the matched color according to the specific color in the color classification iconic code that indicates the product category; if the product of waste source consists of more than one ingredient, the entire color classification iconic code can contain more colors, among which the color (also the color that represents the main material of the product) that indicates the product category has the largest distribution area in the color classification iconic code, and the matched waste container is in the corresponding color; in this case, although the color classification iconic code is relatively complicated, the color that represents the main material of the product occupies the largest distribution area in the entire color classification iconic code and the waste container is in a simple color, so the children at 3-5 years old and illiterates can also subconsciously classify the waste and discard it into the trash can in the matched color according to this specific color. As a result, the waste of the same category can be collected together conveniently. Moreover, because the product of waste source bears a color classification iconic code, it enables people to further classify the waste later manually or through a computer, with a view to collecting the waste with the same ingredient for processing and improving the recycling value of waste.

### BRIEF DESCRIPTION OF THE DRAWINGS

FIG. 1 shows a color classification iconic code for plastic provided in one embodiment of this invention.

FIG. 2 shows a color classification iconic code for waste paper provided in the alternative embodiment of this invention.

### DETAILED DESCRIPTION OF THE PREFERRED EMBODIMENT

In order to clarify the purpose, technical scheme and advantages of the invention, the content below further details the invention in consideration of the embodiments. It should be understood that the specific embodiments described here are only used to interpret this invention, but not limit it.

The embodiments of this invention offer an approach of disposing the current waste, so that the same type of waste can be collected and recycled conveniently. The embodiments of this invention dispose in this way: it marks different products of waste sources with different color classification iconic codes at the time of production; the color classification iconic code contains at least one specific color used to indicate the category of the product, and this specific color has the maximum distribution area in the color classification iconic code or occupies the entire color classification iconic code; various containers used to contain different wastes are marked with the corresponding colors that indicate product categories in the said color classification iconic codes.

The colors in the said color classification iconic code can be arranged as follows to indicate the corresponding wastes:

Black indicates the toxic recycled waste, especially the toxic mercury-containing button cell discarded anywhere.

Red indicates the discarded burnt product, ash, disposable baby diaper, etc. Brown indicates the glass bottle, iron or other metals, etc.

Blue indicates the waste paper, carton, etc.

Green indicates the kitchen waste, vegetable leaf, fruit leather, weed, withered flower and other biological wastes, which can be used to prepare organic fertilizer.

Yellow, pink, orange, pale purple, pale blue, pale green, pale coffee, pale grey and pale red can all be used to indicate various discarded plastic packaging materials.

If the product of waste source consists of one ingredient only, the entire color classification iconic code contains one color only, and the matched waste container is in the corresponding color. In this way, the color of the color classification iconic code is mapped to the color of the waste container, so even the children at 3-5 years old and illiterates can subconsciously classify the waste and discard it into the trash can in the matched color according to the specific color in the color classification iconic code that indicates the product category. If the product of waste source consists of more than one ingredient, the entire color classification iconic code can contain more colors, among which the color (also the color that represents the main material of the product) that to indicates the product category has the largest distribution area in the color classification iconic code, and the matched waste container is in the corresponding color. In this case, although the color classification iconic code is relatively complicated, the color that represents the main material of the product occupies the largest distribution area in the entire color classification iconic code and the waste container is in a simple color, and the children at 3-5 years old and illiterates can also subconsciously classify the waste and discard it into the trash can in the matched color according to this specific color. As a result, the waste of the same category can be collected together conveniently. Moreover, because the product of waste source bears a color classification iconic code, it enables people to further classify the waste later manually or through a computer, with a view to collecting the waste with the same ingredient for processing and improving the recycling value of waste.

To further facilitate waste recycling, the color with the largest distribution area in the said color classification iconic code is applied to the dominant color graphics, and other colors to the sub-color graphics that represent auxiliary materials in the product; the sub-color graphics is drawn in a color different from that of the dominant color graphics; the number of sub-color graphics depends on the number of auxiliary material types, and different ingredients use different colors. In this way, the wastes such as plastic waste in a big variety can be classified and collected easily, thus creating a condition for their recycling and solving the problem of recycling plastic waste.

For the sake of further recycling waste conveniently, the said dominant color graphics is located at the center of the color classification iconic code, a ring is designed around the said dominant color graphics, and different colors are applied to the said sub-color graphics along the ring according to the number of auxiliary material types. In addition, the arc length ratio of each sub-color graphics along the said ring is equal to the content percentage of the related auxiliary material represented by the sub-color graphics. The ring can also be evenly divided into several parts (for example, the ring is evenly divided into 60 parts) just like the clock scale, and the sub-color graphics is indicated in the ring according to the corresponding percentage. Furthermore, the occupied scale can be marked at the corresponding location of each sub-color graphics, so that the content of each kind of auxiliary material can be observed visually to further facilitate classification and recycling of the waste.

The said dominant color graphics and sub-color graphics also bear the content percentages of ingredients represented by them in the product. This helps to visually observe the content of an auxiliary material in the product and facilitates further classification and recycling of the waste.

The said color classification iconic code is pasted or printed on the product of waste source.

To further facilitate classification and recycling of wastes, all the wastes are differentiated, and the said dominant color graphics is drawn in a rectangle, X-shape, arrow, circle, triangle, square, hexagon or an octagon. For example, the parallelogram can be used to indicate waste paper, the triangle to indicate glass bottle, iron and other metals, the rectangle to indicate incinerated waste, the X-shape to indicate toxic chemical, the arrow to indicate biological waste, the hexagon to indicate glass bottle, iron and other metals, the square to indicate thermoplastic, the octagon to indicate thermosetting plastic, etc.

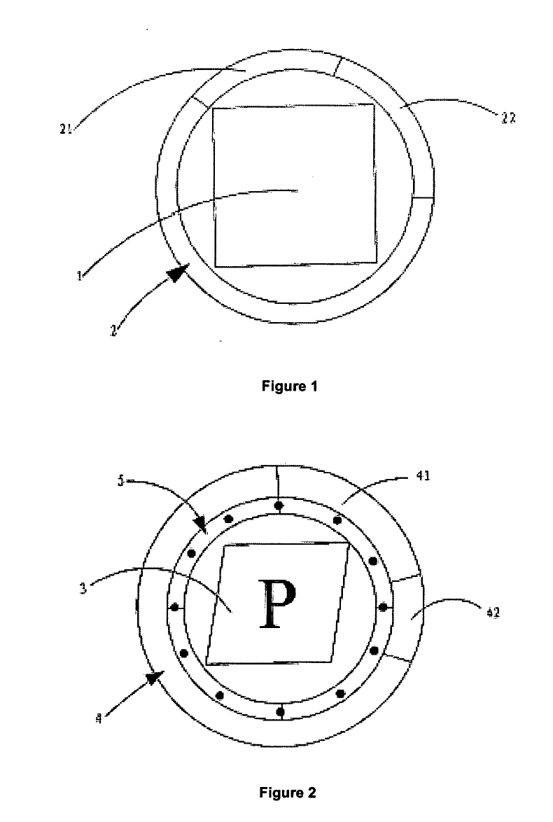

As shown in FIG. 1, one embodiment of this invention uses one color classification iconic code applied to one type of plastic, where Square 1 in yellow represents the main material in the thermoplastic, Arc 21 in pale yellow in Ring 2 represents an auxiliary material in the thermoplastic; and Arc 22 in pale green represents another auxiliary material in the thermoplastic. The above color classification iconic code is labeled to the thermoplastic product when it is produced, and the same type of color classification iconic codes are respectively labeled to the containers prepared to contain various wastes. The waste with this color classification iconic code is discarded into the container with the same color classification iconic code, so that the thermoplastic waste can be collected together manually or through a computer, and then recycled conveniently.

Furthermore, the said dominant color graphics can bear an English letter used to distinguish the product of waste source from other products of waste sources, e.g. P can be used to indicate waste paper.

As shown in FIG. 2, the embodiment of this invention uses one color classification iconic code applied to a type of waste paper, where Big Ring 4 and Small Ring 5 are designed, and Small Ring 5 is divided evenly into 12 parts in the form of clock scale. Parallelogram 3 in blue in Small Ring 5 represents the main material in the waste paper, and English letter “P” is used to indicate paper. Arc 41 in coffee of Big Ring 4 represents one auxiliary material in the waste paper, and Arc 42 in purple represents to another auxiliary material in the waste paper. In this way, people can visually observe the content of an auxiliary material according to the scale in Small Ring 5, so as to further classify and recycle the waste. In addition, the said color classification iconic code is labeled to the product of the waste paper source when it is produced, and the same type of color classification iconic codes are respectively labeled to the containers prepared to contain various wastes. The waste paper with this color classification iconic code is discarded into the container with the same color classification iconic code, so that the waste paper can be collected together manually or through a computer, and then recycled conveniently.

To further facilitate waste recycling, this embodiment also uses the color classification iconic code identified manually or through a computer to collect the waste with the same main material and auxiliary materials. Therefore, the same type of waste collected can be disposed in the same way, improving the possibility of recycling waste. Take the plastic waste for an instance: there are numerous types of plastics and different plastics consist of different ingredients. If these plastics are collected together for re-processing, there is little utilization value because different plastics have respective natures. The possibility of recycling is greatly reduced, or nothing can be recycled. In addition, it is almost impossible to separate the collected plastic wastes at the time of processing, or the cost to do so is too high. However, if the wastes are preliminarily classified at the time of collection and the same type of plastic is collected together, then the color classification iconic code labeled on it can be identified manually or through a computer, and the plastic waste with the same main material and auxiliary materials is collected together. This helps to improve the possibility of recycling the plastic waste, not only tackling the environmental protection problem arising from waste in a country or even throughput the world, but also maximizing the utilization of social resources.

The above description is only intended to demonstrate a preferred embodiment of the present invention, and not to limit this invention. Any change, modification, substitution of equivalents and improvement may be made to the embodiments without departing substantially from the spirit, principle and scope of the invention.

What is claimed is:

1. An approach of disposing waste for marking different products of waste sources with different color classification iconic codes at the time of production, wherein said color classification iconic code contains at least one specific color used to indicate the category of the product, and said specific color has the maximum distribution area in the color classification iconic code or occupies said entire color classification iconic code, wherein said various containers used to contain different wastes are marked with the corresponding colors that indicate product categories in the said color classification iconic codes.

2. An approach of disposing waste, as stated in claim 1, wherein said product category depends on the main material in the product: the color in the color classification iconic code used to indicate the main material of the product is applied to the dominant color graphics, wherein the other colors that indicate auxiliary materials are applied to the sub-color graphics, wherein the sub-color graphics is drawn in a color different from the color of the dominant color graphics, wherein the number of sub-color graphics is decided by the number of auxiliary material types, wherein different colors are used to represent different ingredients.

3. An approach of disposing waste, as stated in claim 2, wherein said dominant color graphics is located at the center of the color classification iconic code, wherein a ring is designed around the dominant color graphics, wherein said different colors are applied to sub-color graphics along the ring according to the number of auxiliary material types.

4. An approach of disposing waste, as stated in claim 3, wherein the arc length ratio of each sub-color graphics along the ring is equal to the content percentage of the related auxiliary material represented by the sub-color graphics.

5. An approach of disposing waste, as stated in claim 4, wherein said ring is evenly divided into several parts just like the 60-minute scale of a clock, wherein said sub-color graphics is shown in the ring according to the related ratio, wherein said occupied scale is marked at the corresponding position of each sub-color graphics.

6. An approach of disposing waste, as stated in claim 4, wherein said dominant color graphics and sub-color graphics are marked with the content percentages of ingredients represented by them in the product.

7. An approach of disposing waste, as stated in claim 1, wherein said color classification iconic code is pasted or printed on the product of waste source.

8. An approach of disposing waste, as stated in claim 2, wherein said dominant color graphics is drawn in a rectangle, X-shape, arrow, circle, triangle, square, hexagon or an octagon.

9. An approach of disposing waste, as stated in claim 2, wherein said dominant color graphics is marked with an English letter that distinguishes one product of waste source from the other products of waste sources.

10. An approach of disposing waste, as stated in claim 2, wherein said color classification iconic code is identified through manual or computer scanning, so that the wastes with the same of main material and auxiliary materials are recycled together.

11. An approach of disposing waste, as stated in claim 3, wherein said color classification iconic code is identified through manual or computer scanning, so that the wastes with the same of main material and auxiliary materials are recycled together.

12. An approach of disposing waste, as stated in claim 4, wherein said color classification iconic code is identified through manual or computer scanning, so that the wastes with the same of main material and auxiliary materials are recycled together.

13. An approach of disposing waste, as stated in claim 5, wherein said color classification iconic code is identified through manual or computer scanning, so that the wastes with the same of main material and auxiliary materials are recycled together.

14. An approach of disposing waste, as stated in claim 6, wherein said color classification iconic code is identified through manual or computer scanning, so that the wastes with the same of main material and auxiliary materials are recycled together.

15. An approach of disposing waste, as stated in claim 1, wherein said color classification iconic code is identified through manual or computer scanning, so that the wastes with the same of main material and auxiliary materials are recycled together.

16. An approach of disposing waste, as stated in claim 8, wherein said color classification iconic code is identified through manual or computer scanning, so that the wastes with the same of main material and auxiliary materials are recycled together.

17. An approach of disposing waste, as stated in claim 9, wherein said color classification iconic code is identified through manual or computer scanning, so that the wastes with the same of main material and auxiliary materials are recycled together.
